(19) United States
(12) Patent Application Publication
(10) Pub. No.: US 2006/0105818 A1
(43) Pub. Date: May 18, 2006

(54) Telecommunication terminal comprising a memory for storing acoustic effect data

(76) Inventors: Markus Andert, Nordstemmen (DE); Frank Blaimberger, Bobingen (DE); Walter Engl, Feldkirchen-Westerham (DE); Alexander Jarczyk, Freising (DE); Roland Keller, Munchen (DE); Matthias Schneider-Hufschmidt, Munchen (DE); Kathleen Stahlberg, Plainsboro, DE (US)

Correspondence Address: BELL, BOYD & LLOYD, LLC, P. O. BOX 1135, CHICAGO, IL, 60690-1135, US

(21) Appl. No.: 10/526,123

(22) PCT Filed: Aug. 1, 2003
(86) PCT No.: PCT/DE03/02587

§ 371 Date: Sep. 23, 2005

(30) Foreign Application Priority Data
Aug. 28, 2002 (DE) 102 39 588.8

(51) Int. Cl. H04M 1/00

(52) U.S. Cl. 455/569.1

(57) ABSTRACT

A telecommunication terminal is provided which includes a recording device for recording acoustic user information, a memory for storing acoustic effect data, and a mixing device which is embodied in such a way that, in a mixing mode of operation, the acoustic user information recorded by the recording device is modified using the acoustic effect data stored in the memory. The telecommunication terminal also includes a control device which is connected to the mixing device and automatically ends the mixing mode after a predetermined operating mode.

### BACKGROUND OF THE INVENTION

The present invention relates to a telecommunication terminal having a recording device for recording acoustic user information, particularly voice information, a memory for storing acoustic effect data, and a mixing device connected to the recording device and memory and embodied in such a way that in a mixing mode of operation the acoustic user information recorded by the recording device is modified using acoustic effect data stored in the memory.

European patent application EP 1 109 379 A1 (ASCOM AG) describes a telecommunication terminal for transmitting voice information. The terminal enables the voice information to be accompanied by stored background sounds or background music. The telecommunication terminal disclosed according to the above-cited document has the disadvantage that the telecommunication terminal or, as the case may be, the voice information requiring to be transmitted can be individualized only to a very limited extent. Specifically, the method disclosed in such document only enables permanent accompaniment by background sounds or music, which accompaniment can be manually deactivated as and when required. A possibility of further individualizing a telecommunication terminal by modifying the voice information or other transmitted information also by brief supporting or embellishing information or with supplementary emotive information is not known.

The present invention is, therefore, directed toward a telecommunication terminal that enables individualizing by modifying user information requiring to be transmitted in a manner that is both flexible and commensurate with a specific situation.

### SUMMARY OF THE INVENTION

Such is achieved via a telecommunication terminal comprising a recording device for recording acoustic user information, particularly voice information, a memory for storing acoustic effect data, and a mixing device connected to the recording device and memory and embodied in such a way that in a mixing mode of operation the acoustic user information recorded by the recording device is modified using acoustic effect data stored in the memory. The telecommunication terminal furthermore has a control device which is connected to the mixing device and by which the mixing mode of operation, having been started, is automatically terminated on expiration of a predefined operating period.

When the above-described telecommunication terminal or, as the case may be, mixing device is in the mixing mode of operation, acoustic user information recorded by the recording device will be modified in the mixing device using the stored acoustic effect data. The control device determines the operating period assigned to the acoustic effect data, it being possible to do so, for example, before the mixing mode of operation starts or while the mixing mode of operation is in progress. The control device terminates the mixing mode of operation automatically upon expiration of the (predefined) operating period.

Thus embodied telecommunication terminals permit acoustic user information to be very flexibly modified and accommodated to specific situations. Determining an operating period assigned to the acoustic effect data both enables acoustic user information to be provided with background sounds or music of longer duration and allows, for example, emotive voice information to be accompanied or supported by brief sounds such as, for instance, a fanfare or gong. The acoustic effect data furthermore may include control data such as, for instance, a maximum volume to be transmitted or specific conditions for applying the acoustic effect data (for example, the condition that, in the case of a mobile telephone, acoustic effects are only possible when communication partners are contained in the mobile telephone's address book).

Telecommunication terminals according to one embodiment of the present invention may be, for example, any type of fixed-network or mobile telephones, but also may be, for example, devices equipped with telecommunication modules (for example, mobile radio modules) such as, for instance, what are termed organizers or palmtops having GSM (Global System for Mobile communications) or UMTS (Universal Mobile Telecommunications System) mobile radio modules. Telecommunication terminals also may include devices connected to a data network such as, for instance, computers embodied for transmitting voice and/or recording voice and/or feeding out voice (Voice-over-IP systems, for example).

With reference to the present invention, recording devices can be, for example, various types of acousto-electrical transducers such as microphones for recording acoustic information. Memories in terms of the present invention can be, for example, electronic storage components and optical or magnetic memories. The memory furthermore may be contained at least partially within exchangeable elements such as, for instance, chip cards or exchangeable memory modules (a multimedia card, for example). It is also possible that, particularly when telecommunication terminals are embodied as mobile telephones, the memory in this regard is provided at least partially within what are termed interchangeable housing shells, with it being possible to provide, for instance, electrical contacts both on at least one housing shell and on a base component (in this instance, having the recording device, mixing device, etc.) encompassed by such shell for the purpose of accessing a memory of this type.

To enable the control device to determine the predefined operating period, which is to say the period of time during which the mixing device's mixing mode of operation has been activated, with minimal technical effort, the (predefined) operating period may be stored in the memory. To determine the (predefined) operating period, the control device only needs to read it from the memory area and, after the mixing mode of operation has started, then terminate it automatically upon expiration of the (predefined) operating period.

The telecommunication terminal can, in a further advantageous embodiment be embodied in such a way that the acoustic effect data includes tone data or, as the case may be, sound data and that the mixing device is embodied in the mixing mode in such a way that the acoustic user information is accompanied in the mixing mode by the tone data (sound data). Tone data (sound data) can be, for example, sound or music data stored in electronic form. Data of this kind can be stored in, for example, analog form (such as on music cassettes, for instance) or in digital form, in certain circumstances also compressed form employing, for instance, what is termed WAV or MP3 format. Tone data (sound data) generally may include, for example, short warning tones, emotive sounds, or short tunes (ingles) (examples include the sound of a hooter, bell, laughter, a fanfare, a signature tune, and a signal tone or melody).

The mixing device then may supply the tone data (sound data) as a background to the entered acoustic user information, wherein the recipient of the acoustic user information will hear the tone data as being superimposed on the user information. As such, for example, mixing voice information with background music or a background sound may occur. The control device will then terminate background mixing automatically upon expiration of the operating period. The operating period also can, however, be “unending” (“unending” can be represented by, for example, a character string provided specially for the purpose) so that the mixing mode of operation persists, for example, until manually terminated by the user (for example by a stop key provided for the purpose) or until the telecommunication connection has been terminated.

The acoustic effect data also may include characteristic tone data or, as the case may be, tone control data, with the telecommunication terminal including a tone data generator, connected to the memory and mixing device, for generating tone data (sound data) from the characteristic tone data and, furthermore, with the mixing device being embodied in the mixing mode of operation for providing the acoustic user information with a background of the tone data (sound data) generated from the characteristic tone data. Storing characteristic tone data (for example, MIDI data; MIDI: Musical Instrument Digital Interface) can enable acoustic supplementary information to be stored more efficiently. Tone data (sound data) is generated from the characteristic tone data a tone data generator (a synthesizer, for example), which tone data is then provided as a background for the acoustic user information in the form of, for example, a background sound or background music or as a signal tone.

When the acoustic user information is modified or, as the case may be, manipulated using the acoustic effect data, the operating period may substantially correspond to a duration of play of the acoustic effect data. As such, the control device tracks, for example, the stream of the acoustic effect data to the mixing device and recognizes when the data stream has ended. As an instance, the control unit can measure, for example, the duration of play of the acoustic effect data while the user information is being modified and deactivate the mixing mode of operation when there is no more acoustic effect data. The control device also can, however, determine the volume of the acoustic effect data and, with cognizance of, for example, the data format employed, calculate a duration of play.

The acoustic effect file furthermore may have a (predefined) duration of play. If the duration of play of the acoustic effect data is shorter than the (predefined) operating period stored (in the memory, for example), the mixing device can be embodied in such a way that the acoustic effect data is used repeatedly until the operating period has expired and the control device terminates the mixing mode of operation.

A repetition factor also may be stored in, for example, the memory, with it then being possible for the operating period to substantially correspond to the product of the repetition factor and a duration of play of the acoustic effect data. The duration of play of the acoustic effect data can, here in turn, be determined by observing or, as the case may be, measuring the stream of the acoustic effect data or by determining the volume of the acoustic effect data. The duration of play furthermore may be stored in the memory. If a repetition factor of 1 assigned to the acoustic effect data has been stored in the memory, the operating period will correspond to the above-described operating period. The stored acoustic effect data, such as tone data (sound data) or tone data obtained from characteristic tone data, will be repeated correspondingly often for larger repetition factors. For a repetition factor of “unending” (“unending” can be represented by, for example, a character string provided specially for the purpose), the stored acoustic effect data, such as tone data (sound data) or tone data obtained from characteristic tone data, will be repeated until the mixing mode of operation is manually terminated by, for example, the user or until the communication connection overall has been terminated.

The emotive content, for example, of call information can be selectively intensified by changing the number of repetitions. As an instance of this, the playing once only of a fanfare signal or the sound of laughter can have a weaker effect compared to playing the same signal twice or thrice or, as the case may be, repeating it.

In a further embodiment of the present invention, the acoustic effect data may include distortion characteristics, with the mixing device being embodied in the mixing mode of operation for distorting the acoustic user information using the distortion characteristics.

The above-mentioned directive is also achieved according to a further embodiment of the present invention by a telecommunication terminal having a recording device for recording or, as the case may be, registering acoustic user information, particularly voice information, a memory for acoustic effect data, and a mixing device connected to the recording device and memory, with the memory furthermore including distortion characteristics and the mixing device being embodied in the mixing mode of operation for distorting the acoustic user information using the distortion characteristics.

Distorting is to be understood in this connection, generally, as being the selective modification of the shape of the frequency spectrum of the acoustic user information in the mixing device. It includes, for example, any targeted limiting or re-weighting of different frequency ranges of the frequency spectrum of the acoustic user information.

Alongside providing acoustic user information with a background of tone data (sound data), distorting of the acoustic user information makes possible a novel, additional dimension of a modification of acoustic user information in keeping with the specific call and situation. It is possible, for example, for voice information to be modified in keeping with the respective call situation in such a way that, for instance, on difficult calls the voice is somewhat attenuated or, in humorous sections of a call, the speaker's voice is changed into a Mickey Mouse voice or modified by being given another humorous vocal characteristic. An operating period can be added to the distortion characteristics in this case as well. It is possible in this way to implement a brief or a longer distortion or one which, after the start, is of unlimited duration. When distortion characteristics are temporally modified, this also may be performed once, twice, or for an unlimited period taking a repetition factor into account.

To make the telecommunication terminal and acoustic modification effects easier to operate, the telecommunication terminal advantageously includes a start control element for starting of the mixing mode of operation by a user and/or a stop control element for terminating the mixing mode of operation by a user. The cited control elements can be control elements already present on the telecommunication terminal such as, for instance, numeric keys, other function keys, or programmable keys (soft keys), as well as rotary buttons, rotary switches, rocker keys, or toggle switches. The start control element and stop control element can be either different control elements or the same control element, with it being possible in the second instance for one key to function as, for example, the start control element when the mixing mode of operation has been deactivated, and for such key to serve after the mixing mode of operation has been started as a stop control element for terminating the mixing mode of operation. If the telecommunication terminal includes supplementary devices connected to a basic device, start control elements and/or stop control elements also may be attached to the supplementary device. In this case, such elements can be, for example, keys or rotary and/or toggle switches.

Internal handling of the acoustic effect data can be simplified if the acoustic effect data is combined within the memory in a higher-order data object; for example, within an acoustic effect file. In this way, it is possible to make it simpler to, for example, organize the data or to move it within the memory or, via a telecommunication connection, to other devices. Accessing of the acoustic effect data is also simplified thereby, for example. An acoustic effect file of this type furthermore may include an operating period assigned to the acoustic effect data which is contained. The acoustic effect file may include a duration of play of the acoustic effect data and/or a repetition factor. The control device is, in this way, accorded a simple possibility for determining the operating period because the characteristics assigned to the acoustic effect data for the operating period are located directly in the file storing the acoustic effect data. The acoustic effect file can, furthermore, include the operating period.

Further possibilities for modifying user information requiring to be transmitted flexibly and in keeping with a specific situation will be obtained if at least two acoustic effect files each having a set of acoustic effect data have been stored in the memory. Two or more sets of acoustic effect data will, in this way, be present in the telecommunication terminal so that different sets of acoustic effect data can be used depending, for example, on the situation of a call being conducted using the telecommunication terminal. A consequence of this is that the acoustic user information will be modified in different ways in the mixing device.

To enable, for instance, one of the acoustic effect files to be selected in a user-friendly manner when there are two or more acoustic effect files, the telecommunication terminal can also may include a selection control element for selecting at least one of the at least two acoustic effect files. The selection control element can, in this case, be, for example, a key (a numeric key, for instance, or a function key or soft key) or a corresponding rotary or rocker button, also a switch, already provided on the telecommunication terminal.

Starting of the mixing mode of operation can be initiated via, for example, the start control element already cited above once an acoustic effect file has been selected using the selection control element. The selection control element also may be embodied as the start selection control element for starting the mixing mode of operation using the data of an acoustic effect file assigned to the start selection control element. When the start selection control element has been operated, an acoustic effect file assigned to that control element will be selected and a mixing mode of operation started using the acoustic effect data contained in the assigned acoustic effect file. Upon expiration of the operating period, the control device can automatically terminate the mixing mode of operation if it has not already been terminated by a user via a stop control element.

Further advantageous individualizing of the telecommunication terminal may be achieved if the telecommunication terminal includes a housing having at least one exchangeable housing part. The housing of the telecommunication terminal can consist of, for example, two exchangeable housing parts; namely, what is termed an upper housing shell and what is termed a lower housing shell.

Exchangeable housing parts of telecommunication terminals are frequently used to match a telecommunication terminal's outward appearance to a user's specific wishes and conceptions. This individualizing can be extended further if the exchangeable housing part includes at least one part of the memory, with at least one part of the acoustic effect data, particularly at least one acoustic effect file, being stored in the at least one part of the memory.

The housing accordingly may include, for example, the entire memory for the acoustic effect data or only a part of the memory for the acoustic effect data, in the second instance being possible for the remaining part of the acoustic effect data to be located in, for example, the telecommunication terminal. The memory housed in the (at least one) exchangeable housing part may include, for instance, a write-protected permanent memory (Read Only Memory: ROM) containing in one or more acoustic effect files acoustic effect data, for example, which has been suitably accommodated to the appearance of the housing part. It also is possible, if the appearance is a cheerful one, to provide cheerful music, one or more suitable jingles, or commensurately humorous voice distortion (Mickey Mouse or a comedian, for instance) via the data stored in the acoustic effect files. If the housing part is exchanged for another housing part different in appearance and having different acoustic effect files contained in the memory of the new housing part, then one or more possibly different types of acoustic effects matched to the appearance of the new housing will be available to the user for modifying acoustic user data to be entered by the user.

The exchangeable housing part also may include at least one housing selection element for selecting at least one part of the acoustic effect data; in particular, one or more acoustic effect files. If a number of acoustic effect files have been stored in, for example, the memory for acoustic effect data of a telecommunication terminal, then via, for example, a housing selection element located on the exchangeable housing part it will be possible to select one or more of the acoustic effect files particularly matching, for example, the appearance of the exchangeable housing part. Selection elements of this type can be, for example, code tags, such as electrical or mechanical contact fields, or mechanical styluses. The start of an operating mode then may be initiated by, for example, operating a start control element or start selection control element assigned to a specific acoustic effect.

By, for example, exchanging a housing part of the telecommunication terminal it is in this way possible to select from among a number of acoustic effect files already stored in the telecommunication terminal specific acoustic effect files matching the appearance of the exchangeable housing part, which files can, in turn, be user-triggerable, for example individually. It is thus possible for a wide array of acoustic effects to be held in store in a telecommunication terminal. These already may have been pre-stored in the memory area for the acoustic effects at the time the telecommunication terminal is supplied or they may be installed later into the memory area of the telecommunication terminal via exchangeable storage elements.

Acoustic effect data or acoustic effect files furthermore may be conveyed to and stored in the memory of the telecommunication terminal other telecommunication devices such as, for instance, from other telecommunication terminals via a telecommunication connection (switched over a telecommunication network, for instance, such as a mobile radio network) or via other components of the telecommunication network (call-processing devices, service-control centers, or devices for additional services in the telecommunication network). Acoustic effect data or acoustic effect files stored in the telecommunication terminal also may be conveyed to other telecommunication devices (other telecommunication terminals, for example, call-processing devices, service-control centers, or devices for additional services in the telecommunication network) via a telecommunication connection (switched over a telecommunication network, for instance, such as a mobile radio network). An exchange of acoustic effect data, for example, may then take place among users of telecommunication terminals who are friends, or additional services can be implemented for making acoustic effects available in the telecommunication network. It should be noted here that acoustic effect data or, as the case may be, files also may be transmitted by users between telecommunication terminals via interfaces installed in telecommunication terminals such as radio interfaces; in particular, Bluetooth interfaces, or infrared interfaces.

Such enabling of user information required to be transmitted to be modified in a manner that is flexible and commensurate with a specific situation is achieved according to a further embodiment of the present invention by a telecommunication terminal including a housing having (at least) one exchangeable housing part, a recording device for recording acoustic user information, particularly voice information, and a mixing device connected to the recording device, with the mixing device being embodied in such a way that, in a mixing mode of operation, the acoustic user information recorded by the recording device is modified and, furthermore, with the exchangeable housing part including the mixing device or, as the case may be, when there is a number of exchangeable housing parts at least one of them including the mixing device. The mixing device of a telecommunication terminal of this type also may be embodied in the mixing mode of operation for providing the acoustic user information with a background of tone data (sound data) and/or for distorting the acoustic user information.

A telecommunication terminal of this type can be embodied, for example, in such a way that the elements required for modifying the acoustic user information are located on the exchangeable housing shell and so do not have to be integrated in a base component of the telecommunication terminal. It can be the case, for instance, that no use of acoustic effects will be possible when certain exchangeable housing shells are used with the telecommunication terminal, while other embodiments of the exchangeable housing elements will make acoustic effects of this type possible.

The base component of the telecommunication device and the exchangeable housing part may include then, for example, respective electrical contact elements for routing the user information registered by the recording device to the mixing device on the exchangeable housing part, and furthermore may include contact elements for routing the modified user information fed out by the mixing device to the further-processing electronic circuitry in the base component of the telecommunication terminal.

Starting and/or stopping of the mixing mode of operation, in turn may be effected via a start control element for starting of the mixing mode of operation by a user and/or a stop control element for terminating of the mixing mode of operation by the user, the elements being attached to the telecommunication terminal. The start and stop control element, in turn may be, for example, control elements already present on the telecommunication terminal. The start or stop control element also may be attached to the exchangeable housing part.

According to a further embodiment of the present invention, a supplementary device or, as the case may be, acoustic device is provided for a telecommunication terminal for modifying entered acoustic user information; in particular, voice information. It is assumed of the telecommunication terminal to be used with the supplementary device that such terminal has an acoustic recording device for recording acoustic user information, particularly voice information, with it being possible to attach the supplementary device for modifying acoustic user information, particularly voice information, to the telecommunication terminal. The supplementary device includes a mixing device having a mixer output area for feeding out modified acoustic user information, with it being possible to attach the mixing device to the telecommunication terminal in such a manner that, in a mixing mode of operation of the mixing device, the modified acoustic user information fed out from the mixer output area is or, as the case may be, can be recorded by the acoustic recording device of the telecommunication terminal.

A supplementary device or, as the case may be, supplementary unit of this type for a telecommunication terminal enables modification of acoustic user information required to be transmitted, such as voice information, outside the actual telecommunication terminal, which consequently does not have to be specifically designed for implementing modification of the user information with acoustic effects. A high degree of flexibility in the use of acoustic effects for individualizing acoustic user data required to be transmitted is achieved in this way. The mixing device here, in turn, may include an electro-acoustic recording element such as, for instance, a microphone, and an electro-acoustic output element such as, for instance, a loudspeaker. The acoustic user data here may be recorded by a microphone, modified in the mixer, then fed out by a loudspeaker. The modified user data that has been fed out then may be recorded by the recording device of the telecommunication terminal. When an electro-acoustic output element is used, it advantageously may be located in the mixer output area of the supplementary device.

The mixing device also may be provided with a mechanical element for integrating acoustic effects into acoustic user information required to be transmitted. Mechanical elements of this type can be, for example, membranes or combinations of membranes that provide the acoustic user information such as, for instance, voice information, with a particular sound characteristic.

A supplementary device of this type having a mixing device can be attached or capable of being attached, for example, externally on the housing of the telecommunication terminal. A supplementary device of this type also may be attached to the interior side of a housing part, particularly an exchangeable housing part, in the vicinity of the acoustic recording device of the telecommunication terminal.

A supplementary device of this type, particularly when attached or capable of being attached to the outside of the telecommunication terminal, also may include a number of mixing devices, with it being possible for such devices to be arranged in a movable fashion and in this way for, in each case, different mixing devices to be brought into a recording area of the recording element of the telecommunication terminal. A number of said mixing devices furthermore may be brought simultaneously into the recording area of the recording device of the telecommunication terminal and, in this way, a combining of the acoustic effects generated by the various mixing devices may be achieved. The mixing devices also may be embodied for providing the entered acoustic user information with a background of tone data and/or for distorting the entered acoustic user information.

Additional features and advantages of the present invention are described in, and will be apparent from, the following Detailed Description of the Invention and the Figures.

### BRIEF DESCRIPTION OF THE FIGURES

FIG. 1 is a schematic of a communication arrangement consisting of a first and a second communication terminal, with the functional elements of a first communication terminal embodied for adding or, as the case may be, integrating acoustic effects being represented.

FIGS. 2A and 2B show instances of supplementary devices for communication terminals or, as the case may be, telecommunication terminals for achieving acoustic effects in voice information required to be transmitted.

### DETAILED DESCRIPTION OF THE INVENTION

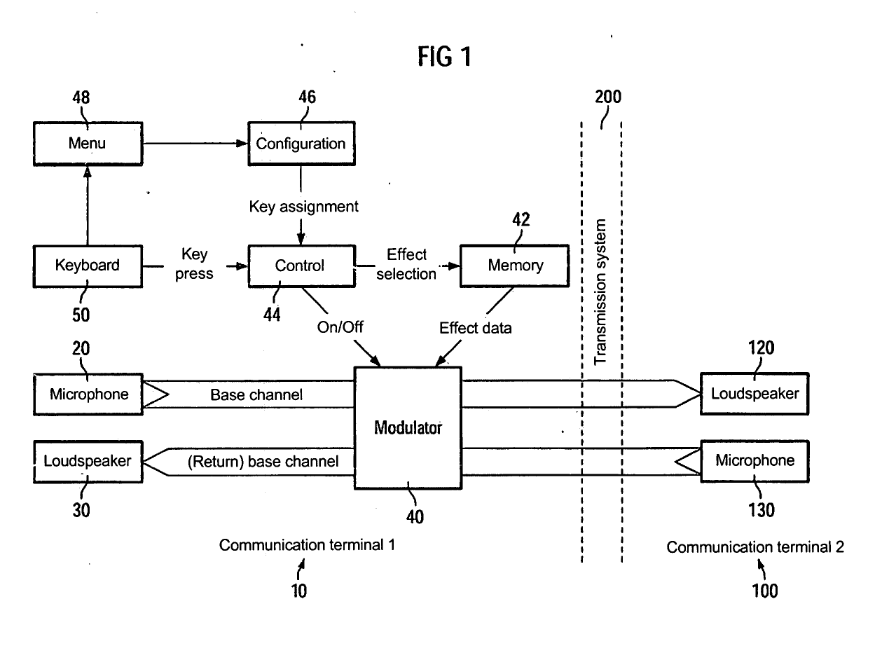

FIG. 1 is a schematic of a communication arrangement consisting of a first 10 and a second communication terminal 100. FIG. 1 shows, in particular, the physical structure of a first communication terminal 10 embodied for adding acoustic effects to voice information required to be transmitted to the second receiving communication terminal 100. The first and second communication terminals can be embodied as, for example, a mobile radio device or, as the case may be, a mobile telephone. The first communication terminal 10 has a microphone 20 by which voice data is recorded and conveyed to a modulator 40 as a mixing device in the first communication terminal 10. The voice data modified in the modulator 40 is transmitted to the second communication terminal 100 via a transmission system 200 capable of transmitting, for example, on a wired basis or at least partially over an air interface. When the first 10 and second communication terminal 100 are embodied as a mobile telephone, the transmission system can be implemented via a mobile radio network operated, in particular, according to the GSM or UMTS standards. The voice data modified in the first communication terminal 10 is then fed out to a second user via a loudspeaker 120 in the second communication terminal 100.

The modulator 40 in the first communication terminal 10 is also able to modify voice signals spoken by the second user into the microphone 130 of the second communication terminal 100 and conveyed to the first communication terminal 10 via the transmission system 200 and feed them out via a loudspeaker 30 of the first communication terminal 10.

Acoustic effect data stored in a memory or storage 42 of the first communication device 10 and combined in a number of acoustic effect files is used in the modulator 40 for modifying the acoustic signals arriving from the microphone 20. It is possible via a control 44 both to select one of a number of acoustic effect files stored in the storage 42 and to activate and deactivate a mixing mode of operation of the modulator 40 in which acoustic signals or, as the case may be, voice signals are modified or, as the case may be, manipulated according to the acoustic effect data. The mixing mode of operation is activated by operating a predefined start key on a keyboard 50. The mixing mode of operation of the modulator 40 can be terminated via the control 44 through automatic termination of the mixing mode of operation by the control 44 upon expiration of a predefined operating period or through pressing of a stop key assigned on the keyboard 50 to terminating the mixing mode of operation, which action causes the control 44 to terminate the mixing mode of operation of the modulator 40.

A configuration file 46 from which the control 44 can ascertain, for example, which of available acoustic effects are to be used or, as the case may be, which acoustic effect data is to be used when the start key on the keyboard 50 is operated is furthermore determined via keys on the keyboard 50 and a menu 48.

The configuration file 46 also may contain, for example, an operating period for the acoustic effect file to be used that is designated in the configuration file 46. Such acoustic effect file equally may be contained in, for example, the memory area of the first communication terminal 10 and filed in the configuration file 46 the menu 48.

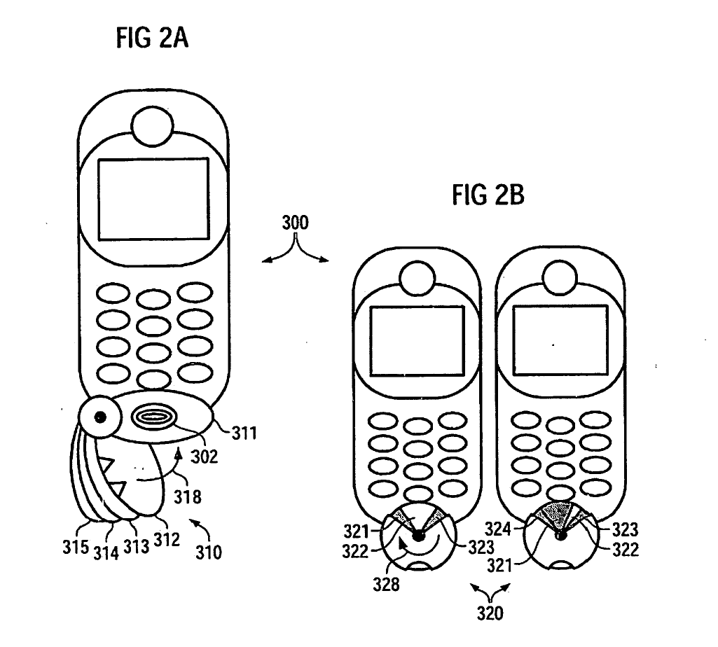

FIGS. 2A and 2B show a communication terminal embodied as a mobile telephone 300 having two different supplementary devices 310, 320. FIG. 2A shows the mobile telephone 300 having a supplementary device 310 containing five different mixing elements or, as the case may be, mixing devices 311 to 315. The mixing elements 312 to 315 are in a passive position and can be moved in the direction of the arrow 318 to a position in front of a microphone (not shown: the microphone is located behind the mixing device 311) of the mobile telephone 300. A first mixing device 311 is already located in front of the microphone and modifies the voice information provided by a user in the direction of the microphone 302 of the mobile telephone 300 in keeping with the characteristics of the mixing element 311. On the front side facing the, user the mixing element 311 may include a microphone 302 and, on the rear side facing the mobile telephone, may include a loudspeaker. The mixing elements 311 to 315 contain within them the corresponding elements for modifying the acoustic information entered.

FIG. 2B shows a mobile telephone 300 having a supplementary device 320, with mixing devices 321 to 324 being arranged in each case in the form of a wheel. The respective wheels of the mixing devices 321 to 324 can be rotated in the direction of the arrow 328 so that different elements from among the mixing elements 321 to 324 can be brought in front of the microphone of the mobile telephone 300. In the left-hand part of FIG. 2B, a first mixer element 322 is positioned in front of the microphone of the mobile telephone 300, while in the right-hand part of FIG. 2B, a second mixing device 321 is now positioned in front of the microphone of the mobile telephone 300 after the corresponding wheel has been rotated. In this way, different acoustic effects may be set by the user by rotating the respective wheel having the various mixing devices 321 to 324. In this case it is also possible for a multiplicity of mixing devices or, as the case may be, mixing elements to be movable simultaneously to a position in front of the microphone of the mobile telephone 300 by rotating the corresponding wheels.

It also is, however, conceivable for all the mixing devices (321-324) to be located on a single wheel so that by rotating the wheel the respective mixing devices can be positioned individually in front of the microphone of the mobile telephone 300.

The present invention describes a telecommunication terminal such as, for instance, a mobile telephone, having a recording device for recording acoustic user information, a memory for storing acoustic effect data, and a mixing device for modifying acoustic user information recorded by the recording device using acoustic effect data stored in the memory. In a case in which the telecommunication terminal has exchangeable elements such as exchangeable housing parts, it is possible to provide the memory and/or mixing device in at least one of the exchangeable elements. According to one embodiment, the acoustic effect data has been assigned a predefined operating period after which a control device contained in the telecommunication terminal automatically terminates the mixing mode of operation. Modification of acoustic user information required to be transmitted that is both flexible and commensurate with a specific situation can be achieved with a telecommunication terminal of this type through it being possible to provide the acoustic user information via different acoustic effect data with a multiplicity of different acoustic effects of short and long duration. According to another embodiment, the acoustic effect data also may include distortion characteristics, with the mixing device finally being designed to, in the mixing mode of operation, distort the acoustic user information using the distortion characteristics.

Although the present invention has been described with reference to specific embodiments, those of skill in the art will recognize that changes may be made thereto without departing from the spirit and scope of the present invention as set forth in the hereafter appended claims.

1-21. (canceled)

22. A telecommunication terminal, comprising:
a recording device for recording acoustic user information;
a memory for storing acoustic effect data, the acoustic effect data including tone data;
a mixing device connected to both the recording device and the memory, such that in a mixing mode of operation the acoustic user information recorded by the recording device is provided with a background including the tone data stored in the memory; and
a control device connected to the mixing device for terminating the mixing mode of operation, after the mixing mode of operation has been started, upon expiration of a predefined operating period, wherein the predefined operating period substantially corresponds to one of a duration of play of the tone data and a multiple of the duration of play of the tone data.

23. A telecommunication terminal as claimed in claim 22, wherein the predefined operating period is stored in the memory.

24. A telecommunication terminal as claimed in claim 22, wherein the acoustic effect data includes characteristic tone data, and the telecommunication terminal further comprises a tone data generator for generating tone data from the characteristic tone data, with the tone data generator being connected to both the memory and the mixing device, and wherein the mixing device provides, in the mixing mode of operation, the acoustic user information with a background of the tone data generated from the characteristic tone data.

25. A telecommunication terminal as claimed in claim 22, wherein a repetition factor is stored in the memory, and the predefined operating period substantially corresponds to a product of the repetition factor and a duration of play of the acoustic effect data.

26. A telecommunication terminal as claimed in claim 22, wherein the acoustic effect data includes distortion characteristics, and the mixing device distorts, in the mixing mode of operation, the acoustic user information using the distortion characteristics.

27. A telecommunication terminal, comprising:
a recording device for recording acoustic user information;
a memory for storing acoustic effect data, the acoustic effect data including distortion characteristics; and
a mixing device connected to both the recording device and the memory, such that in a mixing mode of operation the acoustic user information recorded by the recording device is modified using the acoustic effect data stored in the memory, with the mixing device distorting, in the mixing mode of operation, the acoustic user information using the distortion characteristics.

28. A telecommunication terminal as claimed in claim 27, further comprising at least one of a start control element for starting the mixing mode of operation by a user and a stop control element for terminating the mixing mode of operation by the user.

29. A telecommunication terminal as claimed in claim 27, wherein the acoustic effect data is stored in an acoustic effect file in the memory.

30. A telecommunication terminal as claimed in claim 29, wherein the acoustic effect file includes at least one of a predefined operating period, a repetition factor and a duration of play of the acoustic effect data.

31. A telecommunication terminal as claimed in claim 29, wherein at least two acoustic effect files are stored in the memory.

32. A telecommunication terminal as claimed in claim 31, further comprising at least one selection control element for selecting at least one of the at least two acoustic effect files.

33. A telecommunication terminal as claimed in claim 29, further comprising at least one start control element for starting the mixing mode of operation using the acoustic effect data of the acoustic effect file assigned to the start control element.

34. A telecommunication terminal as claimed in claim 29, further comprising a housing have at least one exchangeable housing part.

35. A telecommunication terminal as claimed in claim 34, wherein the at least one exchangeable housing part includes at least one part of the memory, with at least one acoustic effect file being stored in the at least one part of the memory.

36. A telecommunication terminal as claimed in claim 34, wherein the at least one exchangeable housing part includes at least one housing selection element for selecting at least one acoustic effect file.

37. A telecommunication terminal, comprising:
a housing have an exchangeable housing part;
a recording device for recording acoustic user information; and
a mixing device connected to the recording device such that in a mixing mode of operation the acoustic user information recorded by the recording device is modified, he mixing device being incorporated in the exchangeable housing part.

38. A telecommunication terminal as claimed in claim 37, wherein the mixing device, in the mixing mode of operation, at least one of provides the acoustic user information with a background of tone data and distorts the acoustic user information.

39. A telecommunication terminal as claimed in claim 37, further comprising at least one of a start control element for starting the mixing mode of operation by a user and a stop control element for terminating the mixing mode of operation by the user.

40. An exchangeable housing part for a telecommunication terminal, the telecommunication terminal having a recording device for recording acoustic user information, comprising a mixing device connected to the recording device such that in a mixing mode of operation the acoustic user information recorded by the recording device is modified.

41. A supplementary device for a telecommunication terminal having an acoustic recording device for recording acoustic user information, comprising a mixing device for modifying the acoustic user information, the mixing device including a mixer output area for feeding out modified acoustic user information, wherein the supplementary device may be attached to the telecommunication terminal such that, in a mixing mode of operation of the mixing device, the modified acoustic user information fed out by the mixer output area may be recorded by the acoustic recording device of the telecommunication terminal.

42. A supplementary device for a telecommunication terminal as claimed in claim 41, wherein the mixing device at least one of provides the acoustic user information with a background of tone data and distorts the acoustic user information.
